(19) United States
(12) Patent Application Publication
(10) Pub. No.: US 2022/0356066 A1
(43) Pub. Date: Nov. 10, 2022

(54) Modular, Transportable Plug-in Ammonia Producer

(71) Applicant: Roger Gordon, Georgetown (CA)

(72) Inventor: Roger Gordon, Georgetown (CA)

(21) Appl. No.: 17/728,073

(22) Filed: Apr. 25, 2022

(30) Foreign Application Priority Data
Apr. 26, 2021 (CA) 3116110

(51) Int. Cl. C01C 1/04; C25B 13/00; C25B 1/04; B01D 53/047; C25B 15/08

(52) U.S. Cl. CPC C01C 1/0417; C01C 1/0411; C25B 13/00; C25B 1/04; B01D 53/047; C01C 1/0458; C25B 15/081; B01D 2256/10

(57) ABSTRACT

A plugin modular, transportable ammonia producing machine is developed that can conveniently produce ammonia from electricity, air and water. The invention includes ammonia synthesis through a plugin modular device. FIG. 5 depicts the overall process flow of the system. Water at state 1 enters the system at room temperature in the water storage tank. Next, at state 2, the water in the storage tank is sent to the circulation pump that delivers water to the air compressor. This is done for two main purposes. Firstly, the circulating water cools the compressor during operation. Secondly, as the circulating water rises in temperature while leaving the air compressor, its temperature increases. This results in an increased inlet water temperature to the proton exchange membrane (PEM) electrolyser that leads to higher water electrolysis performance.

### BACKGROUND

### Field of the Invention

The present invention entails the development of a plugin modular, transportable ammonia producer that utilizes only air, water and electricity as system inputs.

### Description of the Related Art

Conventional ammonia synthesis is environmentally detrimental owing to the usage of carbon entailing fossil fuels, which result in significant harmful emissions during usage. Nearly all ammonia production plants across the globe use methane or petroleum based chemicals during synthesis. Also, current ammonia synthesis entails a centralized production where only large chemical plants and industries synthesize this important chemical that is used extensively in various sectors. The patented inventions on ammonia synthesis have primarily focused on the development of new catalysts (U.S. Pat. No. 5,846,507A [1], EP2650047A1 [2], US2015/0353369A1 [3], etc.). Further, ammonia synthesis inventions patented include new proposals for integrated systems and processes (U.S. Pat. No. 4,725,380A [4], U.S. Pat. No. 9,663,381B2 [5], EP0106076B1 [6], DK30214C [7], etc.). Furthermore, ammonia synthesis systems for environmentally benign production have been proposed (US2011/0243828 A1 [8]). However, a modular size plugin ammonia synthesizer built in this invention uniquely develops a working system that provides a portable, transportable, convenient, clean and environmentally friendly method of producing ammonia that can aid in overcoming the challenges of harmful environmental emissions as well as centralized production, which are associated with conventional ammonia production techniques.

### SUMMARY

In one embodiment of the present invention, a new plugin modular ammonia producer is developed that can produce ammonia in an environmentally benign, portable, transportable, decentralized, and convenient method. The plugin system provides the potential to overcome the challenges associated with current centralized ammonia synthesis. At present, the conventional synthesis of ammonia occurs only in large chemical plants. This method of centralized production poses several problems and challenges with the transportation as well as storage of ammonia. Hence, the developed ammonia producer aids in solving these challenges through its transportability that allows it to be taken to any location where ammonia is required. Furthermore, the developed system synthesizes ammonia in an environmentally benign way through the usage of air and water as inputs. Thus, entailing the potential to overcome the massive emission factors associated with the current ammonia synthesis plants. The developed ammonia producer utilizes new design methodologies and system integration techniques for the clean synthesis. The hydrogen required for ammonia synthesis is obtained through a proton exchange membrane electrolyser that produces hydrogen from cooling water of the compressor. In addition, the nitrogen required for ammonia synthesis is obtained through a pressure swing adsorption process that intakes atmospheric air and produces nitrogen gas through a series of adsorption and desorption processes. The produced hydrogen and nitrogen gases are mixed and boosted to the high pressure required for ammonia synthesis through an onboard gas boosting mechanism. Furthermore, the ammonia synthesis reactor entailed with suitable catalyst produce required ammonia gas. Two different techniques of system operation comprising of the cascaded reactor configuration and parallel reactor configuration are entailed in the developed modular clean ammonia synthesis system. The reactor exhaust passes through an air-cooled condenser that allows ammonia to liquefy and separate from the unreacted mixture. Further details about each system component and functionality are enclosed within this document.

### BRIEF DESCRIPTION OF THE DRAWINGS

The figures included provide different views of the system including the right, back, left and front view. In each figure, the major system components required to elucidate the system functionality have been included. Also, schematics and figures of different subsystems required to explain the claims of the present invention are included.

FIG. 1 depicts the right hand view of the developed plugin ammonia producer showing the major components.

FIG. 2 shows the back view of the developed system depicting important parts of the machine.

FIG. 3 displays the left view of the developed ammonia producer.

FIG. 4 shows the front view of the developed system.

FIG. 5 Schematic representing the overall process flow.

FIG. 6 shows the plug in ammonia producer depicting the electrical connections of various components from right view.

FIG. 7 shows the preferred dimensions of the developed modular ammonia producer from different views, however different dimensions are possible and covered by this invention.

FIG. 8 is a schematic of the new water circulation system used in ammonia synthesis.

FIG. 9 shows the components of the new water circulation subsystem used in ammonia synthesis.

FIG. 10 describes the temperature escalation technique for achieving required ammonia synthesis pressures.

FIG. 11 depicts the components of the unreacted mixture recycling loop.

FIG. 12 depicts the components of the reactant mixture pressure boosting subsystem.

FIG. 13 shows the components of the ammonia separation subsystem.

FIG. 14 depicts the schematic of the cascaded reactor system operation configuration.

FIG. 15 shows the schematic of the parallel reactor system operation configuration.

FIG. 16 depicts the components of the cascaded and parallel operation system configurations.

### DETAILED DESCRIPTION

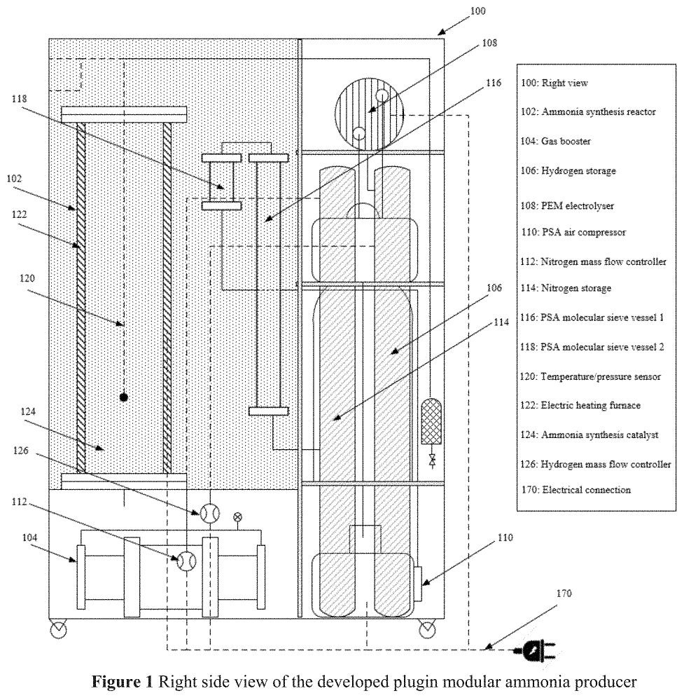

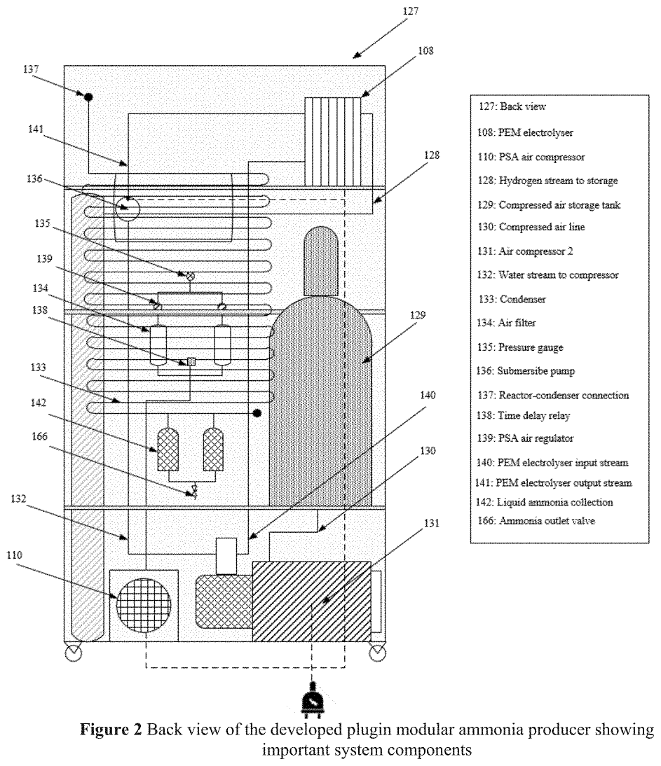

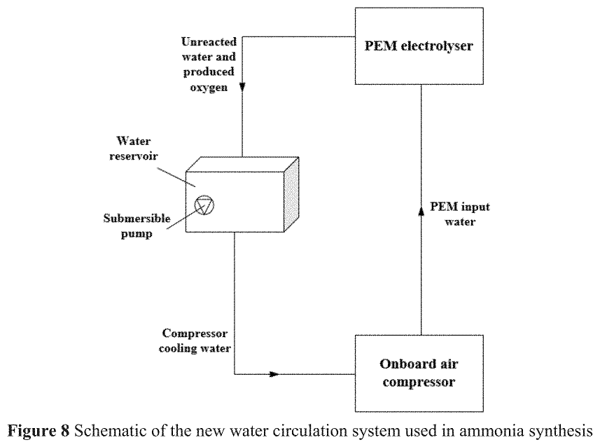

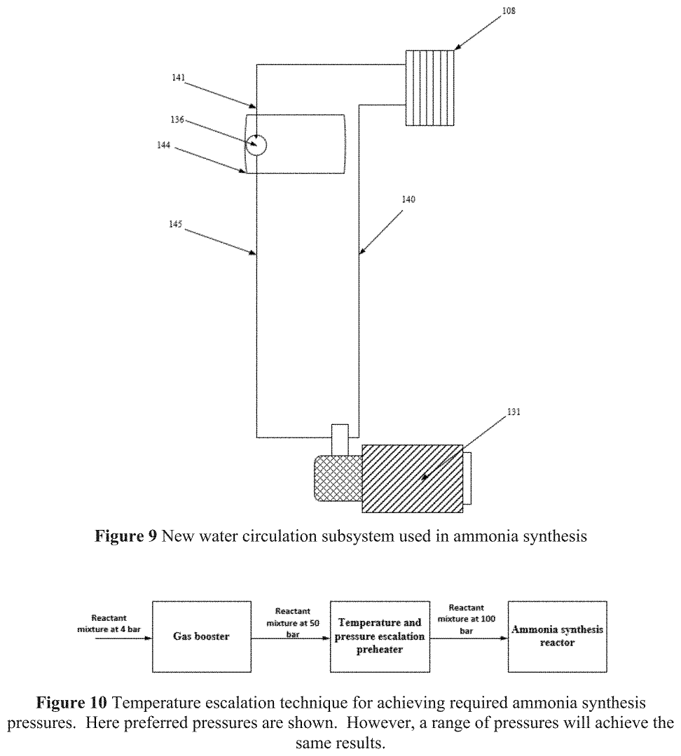

A modular, transportable plugin green ammonia producer is developed that produces ammonia from air, water and electrical input. The preferred plugin system is uniquely designed to enclose all components within preferably a household fridge size compartment and operate with only electricity, water and air as inputs. However, larger or smaller transportable configurations are also claimed. The right hand view 100 is depicted in FIG. 1. The figure shows the major system components that can be viewed from this side of the machine. The tubular reactor 102 is used as the ammonia synthesis reactor. The reactor 102 is made from 316 stainless steel material and entails preferably a height of 34.5 in and preferably an inner diameter of 10 in. Further, the temperatures and pressures inside the reactor are recorded through temperature and pressure sensors 120. The tubular reactor 102 is covered with an electric furnace 122 that utilizes electricity and heating coils to produce thermal energy, which is transferred to the reactor according to the required reaction conditions. This is required during startup and catalyst activation. The ammonia synthesis process is exothermic in nature and as ammonia is produced, the heat generated is used to maintain the reactor at high reaction temperatures. The reactor 102 is filled with a magnetite based commercial catalyst 124 that aids in the synthesis process. In addition, in system 100 the proton exchange membrane (PEM) electrolyser 108 generates onboard hydrogen. The PEM electrolyser 108 is utilized with a unique methodology in the developed system where water is first preheated through the utilization of waste heat from the air compressor 131. Increasing the temperature of input water to the PEM electrolyser 108 aids in enhancing the hydrogen production rates as well as the overall system efficiencies. Thus, a new water circulating design that provides cooling to the air compressor and acts as the input to the water electrolyser to enhance hydrogen production during ammonia synthesis is employed. FIG. 8 included in this document schematically represents this subsystem. A water reservoir with the submersible pump 136 pumps the cooling water required by the onboard air compressor 131. The hot exit water stream of the compressor 131 is passed to the electrolyser 108. This enhances the performance of the PEM electrolyser 108 as higher temperatures enhance the molecular activity and lead to lower polarization losses within the electrochemical cells. Next, the unreacted water along with the produced oxygen exit the electrolyser and are passed back to the reservoir 144. The reservoir is supplied with lower temperature make-up water that cools the hot recycled water. This cooled water mixture flows again to cool the onboard air compressor 131 and the cycle is continued accordingly. FIG. 9 depicts the subsystem and its respective components. Moreover, the nitrogen required for ammonia synthesis is obtained via the process of onboard pressure swing adsorption (PSA). This nitrogen generation system entails various subsystems and components. In FIG. 1, the air compressor 110 is part of the PSA system, which intakes atmospheric air and pressurizes it preferably to 4-5 bar. This pressure is required to conduct the adsorption followed by desorption processes. The air compressor 110 pressurizes atmospheric air and sends it to an enclosed container 118 filled with carbon molecular sieves. The pressurized atmosphere within the container 118 and the presence of molecular sieves allows the adsorption of oxygen molecules from air. Thus, once the oxygen molecules are adsorbed, the remaining nitrogen molecules are allowed to exit the container and enter another enclosed compartment 116. The oxygen adsorbed is allowed to desorb through a pressure swing that is produced by controlling the air compressor via a time delay relay 138. Further, onboard storage of hydrogen and nitrogen is achieved through storage vessels 114 and 106. The hydrogen produced is stored in storage vessel 106 and the nitrogen produced is stored in the storage vessel 114. Storage vessels are essential to control the inflow of gases into the reactor 102 where the mixture of hydrogen and nitrogen is sent with the required stoichiometric ratio that entails 1 mole of nitrogen gas for every 3 moles of hydrogen gas. A reactant mixture of this molar ratio is obtained through the usage of mass flow controllers. The mass flow controller 112 controls the flow rate of nitrogen and the flow controller 126 controls the hydrogen flow rate. Next, the required reactant mixture entailing hydrogen and nitrogen with the appropriate molar ratio enters the gas booster 104. The gas booster 104 increases the reactant mixture pressure from approximately 4 bar to around 50 bar. The booster 104 operates through a pressurized air input that is also produced onboard as described from the back view of the machine. The back view of the machine is depicted in FIG. 2. This back view 127 also depicts the major system components. The air compressor 110 is a part of the PSA nitrogen generation system as described earlier. The exit of this air compressor 110 is connected to the filter 134. The filter 134 is an essential component of the PSA that ensures no dust or other contaminant particles enter the adsorption and desorption chambers. Also, the flow control valve 135 allows to control the amount of air entering the adsorption chambers. The pressure gauge 139 is installed to obtain the pressure reading across the air inlet flow stream. Since the PSA works on a pressurizing and depressurizing mechanism, a time delay relay 138 is used to control the air compressor 110 operation. The switch on and switch off times for the compressor can be varied according to the desired outputs. Moreover, the submersible pump 136 is submerged in a reservoir containing water. The pump 136 is used to pump the stored water for two purposes simultaneously. Firstly, the water is pumped for cooling air compressor 131 through the water flow stream 132 where it passes over the compressor components to provide continuous cooling. Cooling the air compressor 131 is essential to ensure the compressor operates within acceptable temperature limits. As the compressor 131 entails significant heat generation due to internal friction and other irreversibilities, it is important to provide continuous cooling during operation. Hence, the water stream 132 passes through compressor 131 for this purpose. After exiting compressor 131, the water stream 140 enters PEM electrolyser 108. In the electrolyser 108, water is dissociated electrochemically into oxygen and hydrogen gases. The unreacted water as well as produced oxygen gas leave the electrolyser through stream 141 to enter the water reservoir. Since water is consumed during electrolysis to produce hydrogen, external make up water is filled in the reservoir 144 periodically. The compressor 131 is an important system component that produces onboard compressed air required for the operation of the gas booster 104. The compressor 131 intakes atmospheric air and pressurizes it preferably to a pressure of 150 bar. This compressed air is stored in tank 129, which it enters through the air stream 130. The compressed air storage tank 129 is important for the operation of the present system as the gas booster 104 requires compressed air inlet pressures of 10 bar to boost the reactant mixture from approximately 4 bar to approximately 50 bar before entering the preheater reactor. In the present embodiment, the tank 129 is used to store compressed air at high pressures of preferably around 150 bar to ensure sufficient supply of air for the gas booster that intakes compressed air at 10 bar. The outlet pressure of the compressed air storage tank 129 is controlled via a pressure regulator 146 to ensure the compressed air enters the gas booster at a preferable pressure of 10 bar. In another embodiment, the storage tank volume can be increased and lower storage pressures can be employed, which will result in lower compressor power inputs. However, in this case the increased tank volume will require increased storage space.

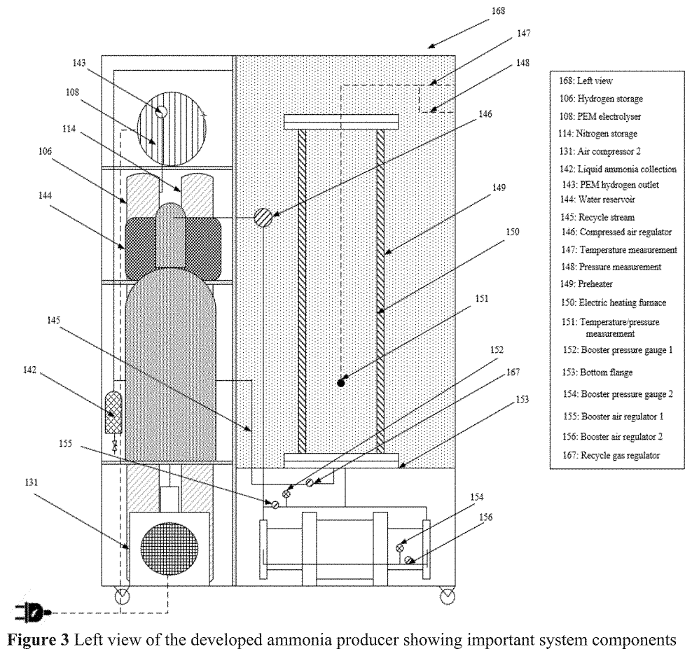

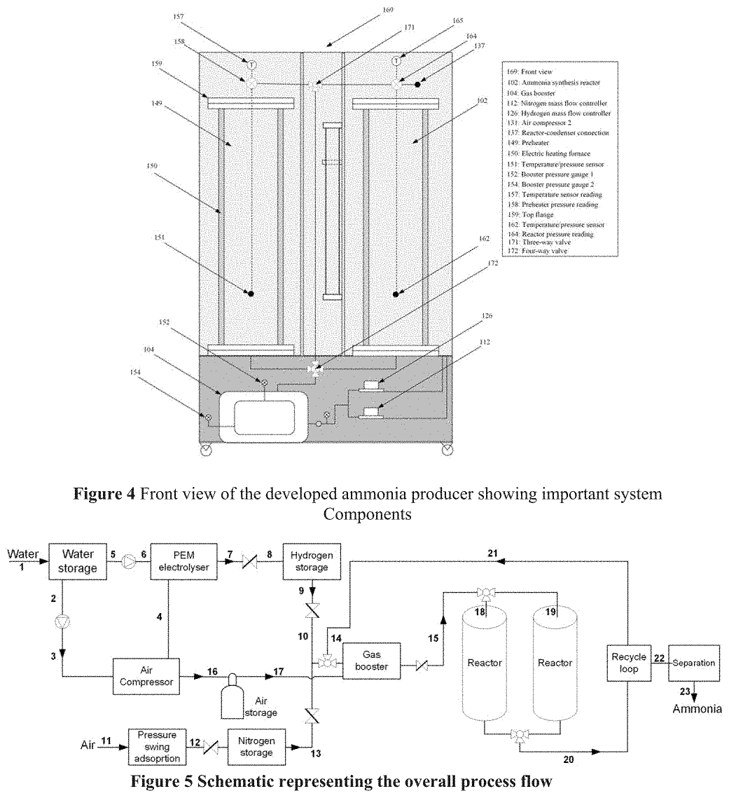

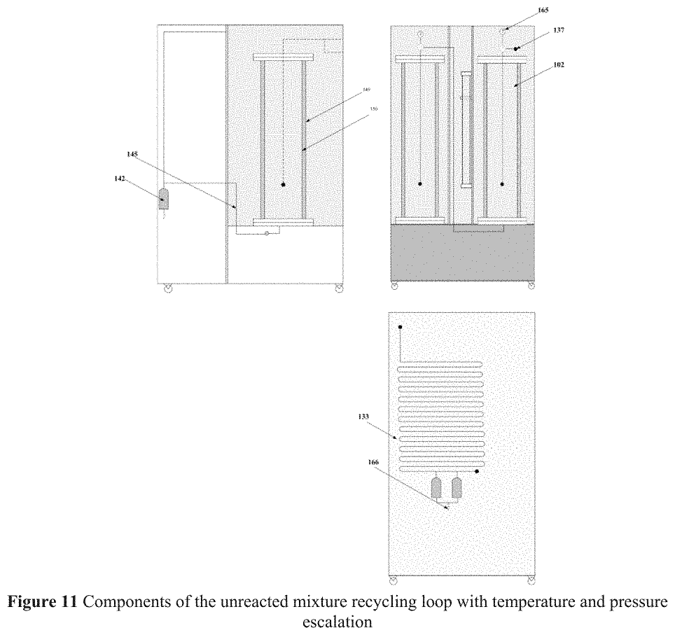

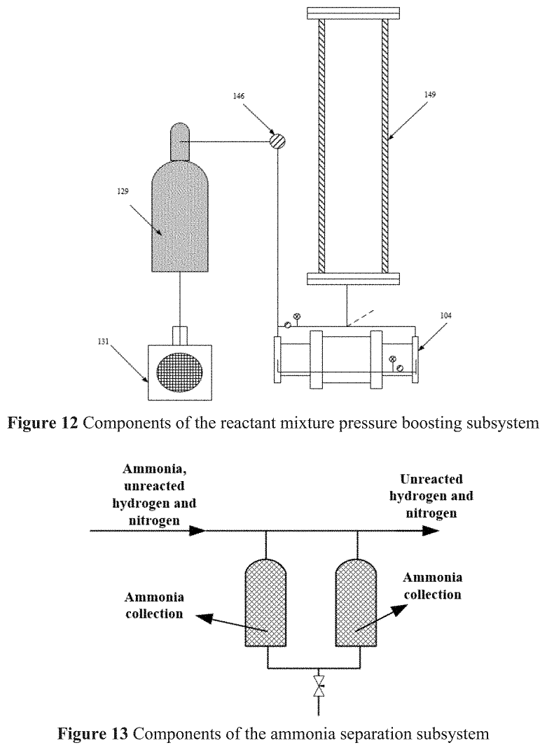

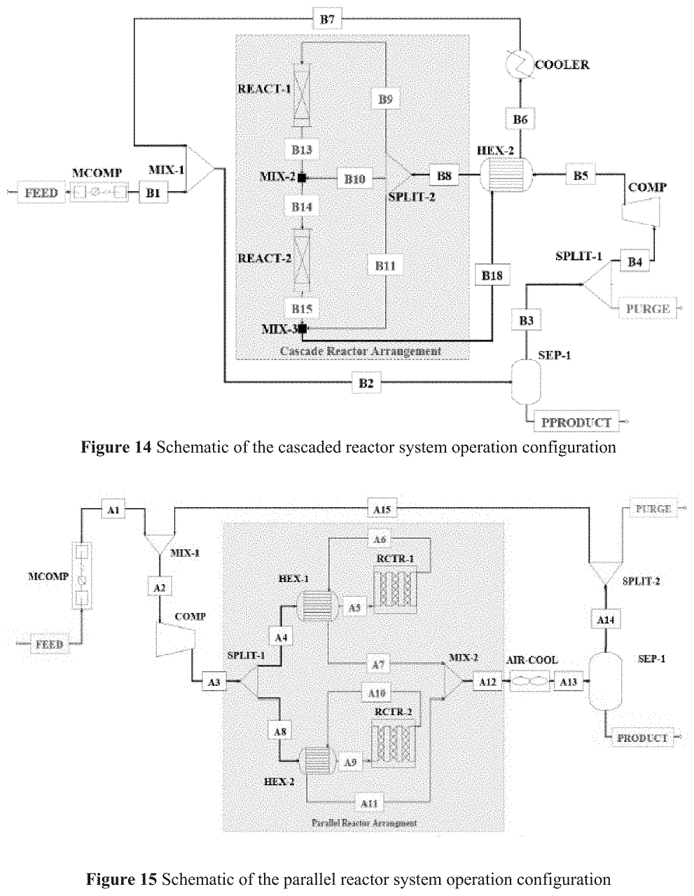

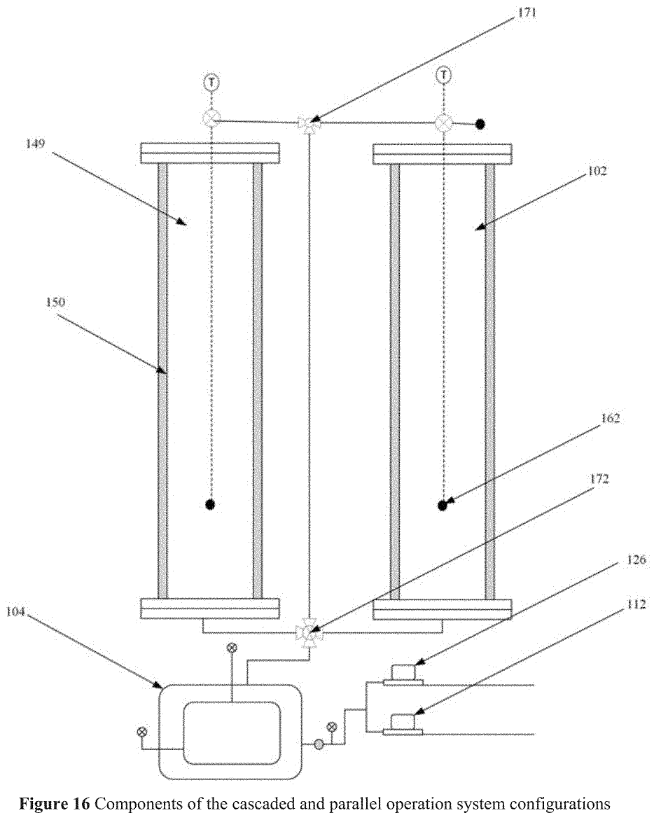

The connection 137 depicts the high-pressure fitting that connects the output of the ammonia synthesis reactor 102 with the condenser 133. The condenser 133 is essential to separate the ammonia produced from the unreacted hydrogen and nitrogen gases. Since the synthesis reactor 102 is operated at high pressure of approximately 100 bar, the produced ammonia is condensed through an air-cooled condenser 133. As the condensation temperature of ammonia increases with pressure, it is liquefied in condenser 133 that entails partial pressures of ammonia according to the conversion rates. The liquid ammonia separates from the mixture and settles down in the ammonia separation subsystem 142. The remaining unreacted hydrogen and nitrogen gases are recycled and sent back to the preheater reactor. The left view of the developed machine is depicted in FIG. 3. Firstly, the hydrogen gas output 143 from the PEM electrolyser 108 is shown, which is connected to the hydrogen storage vessel 106. Moreover, the water reservoir 144 is shown that stores the water required for air compressor 131 cooling as well as hydrogen production. Next, the pressure regulator 146 for the compressed air storage tank 129 is shown, which regulates the inlet air pressure to the gas booster. The gas booster intakes compressed air preferably at 10 bar, hence, the high-pressure tank 129 that stores the compressed air preferably at 150 bar can provide the required air to the booster multiple times owing to the high amount of air stored in the tank. Next, FIG. 11 shows the recycle loop 145 that is essential to reuse the unreacted hydrogen and nitrogen gases. After the liquefied ammonia separates and settles down in the ammonia separation subsystem 142, the unreacted gas mixture passes through loop 145 to enter the preheater reactor 149. Since the stream 145 entails a higher pressure than the preheater 149, it is recycled without the necessity of another gas compressor. Thus, through this new methodology, the unreacted gases are recycled and the ammonia produced is separated without the requirement of an additional refrigeration system. Next, pressure gauges 152 and 154 are components of the gas booster 104 that provide the pressure reading across the booster connections to the preheater reactor and the compressed air storage tank. Also, the flow regulators 155 and 156 allow the flow regulation of input air and reactant mixture to the booster. Further, the preheater reactor 149 is also enclosed in an electric heating furnace 150. Also, the temperature and pressure sensors 151 are installed that allow monitoring of the preheater reactor temperature and pressure that are displayed on the front side of the machine through connections 147 and 148. In the present embodiment, the preheater reactor heats the reactant mixture that entails a pressure of nearly 50-70 bar to at or around 400° C. Also, the synthesis of ammonia occurs during this process. Owing to the temperature rise, the reactant mixture pressure also rises to high values of preferably around 100 bar. Thus, this high-pressure mixture is then allowed to enter the ammonia synthesis reactor 102. FIG. 4 depicts the front view of the developed machine showing the major system components. Firstly, the preheater reactor 149 and ammonia synthesis reactor 102 are shown. Their respective functionalities were described earlier. Furthermore, the temperature and pressure reading displays for the preheater reactor 149 are shown by 158 and 157, whereas the temperature and pressure reading displays for the synthesis reactor 102 are depicted by 164 and 165. Also, the pressurized fitting 137 connecting the reactor with the condenser is shown. The mass flow controllers 126 and 112 for controlling the mass flow rates of nitrogen and hydrogen inputs are also shown in the front view. In one embodiment of the developed system, the electrical inputs required for system components can be obtained via renewable energy resources such as solar and wind energy that will enable the developed ammonia producer to produce environmentally benign ammonia. Moreover, the novelty claims described in the claims section discuss the novel subsystems in the present invention in detail.

### REFERENCES

1. Liu, H., Xu, R., Jiang, Z., Hu, Z., Li, Y., Li, X. (1998). U.S. Pat. No. 5,846,507A. U.S. Patent and Trademark Office.
2. Hosono, H., Hara, M., Kitano, M., Wng Kim, S., Matsuishi, S., Toda, Y., Yokoyama, T., Hayashi, F. (2011). European Patent No. EP2650047A1. European Patent Office.
3. Sekine, Y., Tsuneki, H., Ikeda, M. (2014). U.S. Patent No. US2015/0353369A1. U.S. Patent and Trademark Office.
4. Pinto, A. (1986). U.S. Pat. No. 4,725,380A. U.S. Patent and Trademark Office.
5. Alkusayer, K. T. (2016). U.S. Pat. No. 9,663,381B2. U.S. Patent and Trademark Office
6. Shires, P., Cassata, J., Mandelik, B., Dijk, C. V. (1983). European Patent No EP0106076B1.
7. Patentudnytterne, L. (1920). Denmark Patent No. DK30214C.
8. Gordon, R. (2010). U.S. Patent No. US20110243828A1. U.S. Patent and Trademark Office.

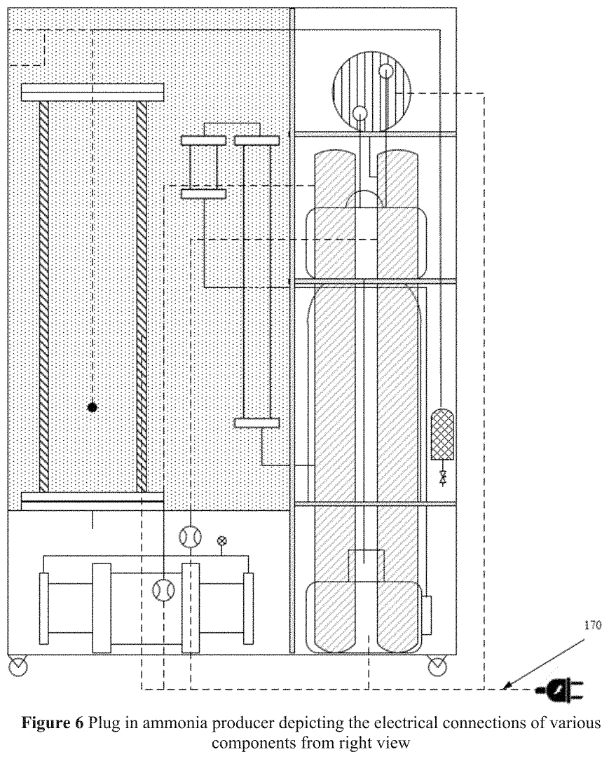

1. A plugin modular, transportable ammonia producing machine is developed that can conveniently produce ammonia from electricity, air and water. The invention includes ammonia synthesis through a plugin modular device. FIG. 5 depicts the overall process flow of the system. Water at state 1 enters the system at room temperature in the water storage tank. Next, at state 2, the water in the storage tank is sent to the circulation pump that delivers water to the air compressor. This is done for two main purposes. Firstly, the circulating water cools the compressor during operation. Secondly, as the circulating water rises in temperature while leaving the air compressor, its temperature increases. This results in an increased inlet water temperature to the proton exchange membrane (PEM) electrolyser that leads to higher water electrolysis performance. Water electrolysis performance increases at higher operating temperatures. Hence, the novel integrated compressor cooling and electrolysis water supply allows the recovery of waste heat in the system to attain higher performances. The hydrogen produced in the PEM electrolyser enters the hydrogen storage tank at state 8 where it is stored at a pressure of 4 bar. Air enters the system at state 11 into the pressure swing adsorption (PSA) air separation unit that generates the required nitrogen. The produced nitrogen is also stored in a nitrogen storage tank at 4 bar. Moreover, the air compressor produces pressurized air at nearly 150 bar that is stored in the air storage tank. Next, the stored air is delivered to the gas booster at nearly 10 bar to the gas boosted to boost the reactant mixture from 4 bar to nearly 50 bar. Furthermore, as the reactant mixture leaves the gas booster it is allowed to enter temperature escalation system or directly into the reactors depending on the mode of operation. After the leaving the synthesis reactor, the mixture of produced ammonia and unreacted gases are passed through the recycle loop where ammonia is separated. Further detailed descriptions of each subsystem and system component are provided in the detailed description section. For an ammonia production rate of 500 L/day, the system consumes 3.5 kW.
FIG. 6 shows the right view of the system depicting important system components. System components requiring electrical inputs include PEM electrolyser, PSA nitrogen generator, air compressors 1 and 2, submersible pump, electric heating furnace and mass flow controllers. These components are connected with the required electrical connections to form one plugin connection that can be used to power the machine. Hence, the modular ammonia producer can be conveniently transported to any location entailing electricity supply and can be plugged in to produce ammonia.

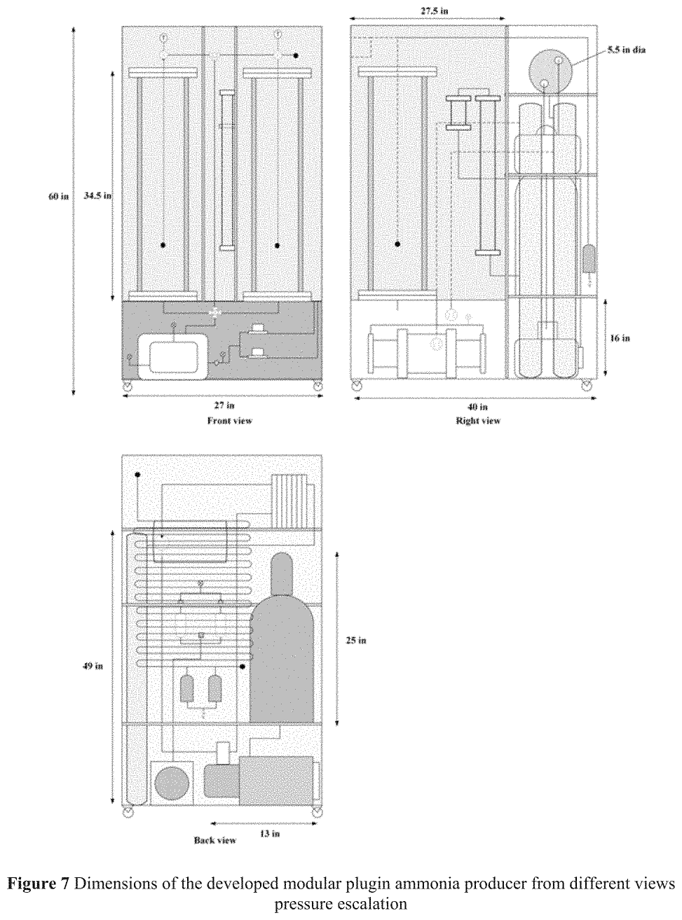

2. A modular size ammonia-producing machine that can synthesize environmentally benign ammonia. The dimensions of an example machine are depicted in FIG. 7. Larger or smaller size configurations are a part of the claim
A typical machine has an approximate length of 27 in, width of 40 in and height of 60 in. Also, in this configuration, the preheater or the first reactor, and ammonia synthesis reactor have an approximate length of 34.5 in and inner diameter of 3 in. These dimensions reflect the small, transportable size and portability of the synthesizer that is one of the claims of the present invention for ammonia synthesis but the claim includes other, larger or smaller sizes provided they allow transportability. Further, as can be observed from FIG. 6, the machine has been equipped with wheels at the bottom for easier transportability. The functionality of each system component has been described in detail in the detailed description section.

3. A new water circulating design that provides cooling to the air compressor 131 and acts as the input to the water electrolyser 108 to enhance hydrogen production during ammonia synthesis. FIG. 8 elucidates the claim schematically. A water reservoir 144 with a submersible pump 136 pumps the cooling water required by the onboard air compressor 131. The hot exit water stream 140 of the compressor is passed to the electrolyser 108. This enhances the performance of the PEM electrolyser 108 as higher temperatures enhance the molecular activity and lead to lower polarization losses within the electrochemical cells. Next, the unreacted water along with the produced oxygen exit the electrolyser and are passed back to the reservoir 144. The unreacted water is stored in the reservoir 144 and recycled in the electrolyser 108.
The reservoir is also supplied with make-up water that entails a lower temperature, which cools the hot recycled water. This cooled water mixture flows again to cool the onboard air compressor and the cycle is continued accordingly. FIG. 9 depicts the subsystem and its respective components.

4-8. (canceled)
